(19) United States
(12) Patent Application Publication
(10) Pub. No.: US 2007/0230896 A1
(43) Pub. Date: Oct. 4, 2007

(54) Techniques for effective trick mode transitions

(76) Inventors: Jason H. Wang, Gilbert, AZ (US); Alex A. Lopez-Estrada, Chandler, AZ (US)

Correspondence Address: KACVINSKY LLC;C/O INTELLEVATE, P.O. BOX 52050, MINNEAPOLIS, MN, 55402, US

(21) Appl. No.: 11/395,415

(22) Filed: Mar. 31, 2006

(51) Int. Cl. H04N 5/91

(52) U.S. Cl. 386/68

(57) ABSTRACT

A system, apparatus, method and article to provide effective output of trick mode content are described. The apparatus may include a decoding module to produce a decoded content stream in accordance with a trick mode. This decoded content stream is based on a portion of a first encoded content stream received in a normal play mode, and a second content stream received in the trick mode. The portion of the first encoded content stream is selected by a control module. Other embodiments are described and claimed.

### BACKGROUND

Consumers have come to expect playback functionality from digital media much in the same way as they are used to in analog recording or playback devices (e.g., a video cassette player). Such playback operations are often classified as belonging to an operational category referred to as “trick mode”. Trick mode playback (or trick playback) may include operations such as fast forward, fast reverse, slow motion, etc. More generally, trick mode provides operations that may need non-sequential access into the formatted media and may include various types of content navigation.

Trick mode playback or trick playback is a highly desirable feature in devices, because they provide users with flexibility when consuming content. Thus, there is a need for effective trick mode techniques.

### BRIEF DESCRIPTION OF THE DRAWINGS

FIG. 1 illustrates one embodiment of an apparatus.

FIG. 2 shows an exemplary implementation embodiment that may be within a decoding module.

FIG. 3 is a diagram illustrating an exemplary operation.

FIG. 4 illustrates one embodiment of a logic flow.

FIG. 5 is a diagram of an exemplary interaction between various entities.

FIG. 6 illustrates an embodiment of a system.

### DETAILED DESCRIPTION

Various embodiments may be generally directed to techniques for the effective output of trick mode content. In one embodiment, for example, a decoding module produces a decoded content stream in accordance with a trick mode. This decoded content stream is based on a portion of a first encoded content stream received in a normal play mode, and a second content stream received in trick mode. The portion of the first encoded content stream is selected by a control module. In this manner, drawbacks, such as scene jumping and delays, can be reduced. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

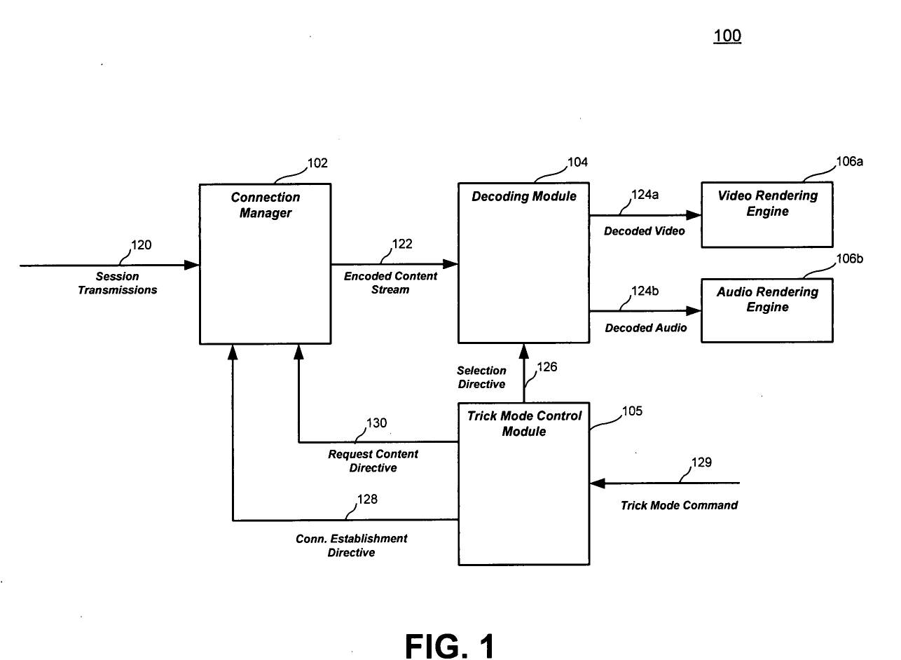

FIG. 1 is a diagram showing an embodiment of an apparatus 100, which may be used to process content, such as image(s), video sequences, audio, and/or graphics. For instance, this system may receive, decode, and/or render content to a user. Such processing may be in accordance with one or more trick mode operations. Examples of trick mode operations may include fast forward, fast reverse, slow motion, etc. Such operations may be invoked, for example, through user input.

As shown in FIG. 1, apparatus 100 may include various elements. However, the embodiments are not limited to these elements. For instance, embodiments may include greater or fewer elements, as well as other couplings between elements.

In particular, FIG. 1 shows that apparatus 100 may include a connection manager 102, a decoding module 104, a trick mode control module 105, and one or more rendering engines 106. These elements may be implemented in hardware, software, firmware, or in any combination thereof.

Connection manager 102 manages connections (e.g., streaming connections) with content sources, such as remote digital media servers (DMSs). This may involve communicating with such sources to perform various functions. Examples of such functions include opening and/or closing connections. In addition, connection controller 102 may receive content (e.g., streaming media) from such sources. For instance, FIG. 1 shows connection 102 receiving session transmissions 120. These transmissions may be in the form of packets containing encoded content (e.g., video and/or audio). As indicated by an encoded content stream 122, such encoded content may be forwarded to decoding module 104 for processing. However, connection manager 102 may also include a buffer to store these packets before sending them to decoding module 104.

Decoding module 104 may decode content that it receives from connection controller 102 (e.g., stream 122) into format(s) accepted by rendering engines 106. When multiple rendering engines are employed, decoding module 104 may route portions of such streams (e.g., audio and video) to appropriate rendering engines 106. In addition, decoding module 104 may include one or more buffers for storing content (e.g., packets) that it receives from connection controller 102.

As described above, apparatus 100 may include one or more rendering engines 106. For example, FIG. 1 shows apparatus 100 having video rendering engine 106a and an audio rendering engine 106b. These rendering engines receive decoded content signals 124 from decoding module 104. With these signals, rendering engines 106 may drive devices, such as displays and/or speakers, to output content.

Trick mode control module 105 may perform operations to control the generation of decoded content (e.g., decoded content signals 124) in accordance with various trick modes. Such operations may be initiated in response to a trick mode command 129 that trick mode control module 105 receives. This command may be the result of a user selection through an interface device. However, the embodiments are not limited to such.

In contrast with a normal play mode, trick modes may include play (or playback) features, such as fast forward, fast reverse, slow motion, etc. Therefore, performance in such modes may involve non-sequential access into content as well as various types of content navigation. To implement such features, trick mode control module 105 may generate various directives. For instance, FIG. 1 shows module 105 generating a selection directive 126, a connection establishment directive 128, and a request content directive 130.

As described above, decoding module 120 may receive and store content (e.g., encoded content) from connection controller 102. Prior to receipt of trick mode command 129, such content is in accordance with a normal (i.e., non-trick) play mode. Based on command 129, directive 126 may select a portion of such stored content to be decoded and/or output in accordance with the trick mode(s) specified in command 129. In addition, directive 126 may specify various characteristics of the trick mode(s), such as play speed, play direction, etc.

Connection establishment directive 128 directs connection manager 102 to establish a session with a content provider in accordance with the trick mode(s) specified in command 129. This is because decoding module 104 may have only a certain amount of buffered content (normal play mode content), which may not be enough for output in accordance with the specified trick mode(s). Therefore, based on directive 128, connection manager 102 will terminate a current content connection establish a second content connection to receive content in the specified trick mode(s).

In addition, trick mode control module 105 may send connection manager 102 request content directive 130. This directive instructs connection manager 102 to request content via the second connection. As described above, such content is in accordance with the specified trick mode(s).

Trick mode control module 105 may send directive 130 at various times. One such time may be when an ending point occurs for decoding module 104 outputting non-trick mode in accordance with the specified trick mode(s) (e.g., when such content is exhausted). Such an ending point may be determined based on trick mode characteristics (e.g., play speed and direction), and techniques applied to locally generate trick mode content from non-trick mode content. Examples of such techniques are provided below.

Apparatus 100 may provide advantages over other techniques, such as ones that only output trick mode content that is based on received content that is encoded according to trick modes. Such advantages may include reduced scene jumping and delays associated with the reception of trick mode content from a remote content provider.

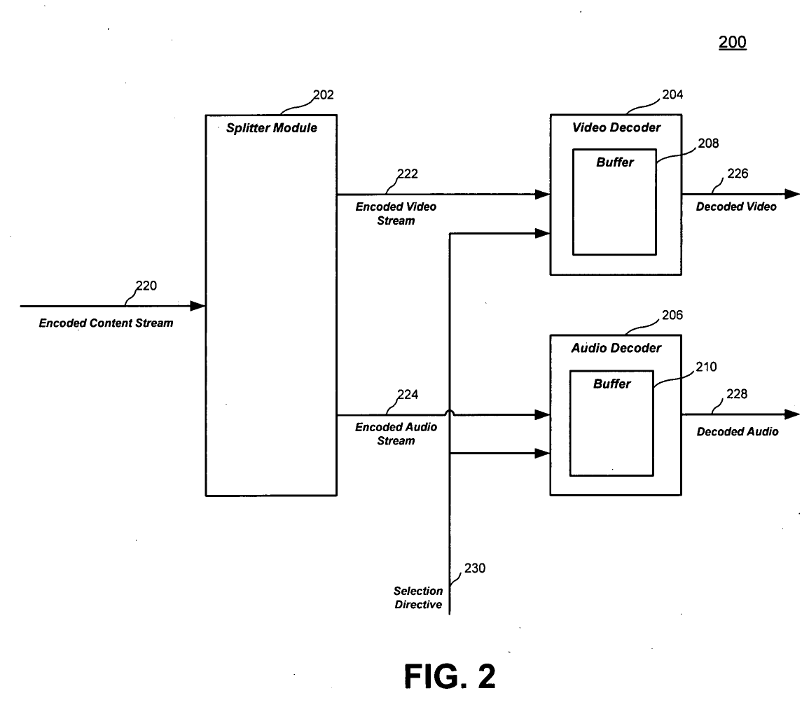

FIG. 2 shows an exemplary implementation embodiment 200 that may be included within decoding module 104. As shown in FIG. 2, this implementation may include various elements. However, the embodiments are not limited to these. For instance, embodiments may include greater or fewer elements, as well as other couplings between elements. In particular, FIG. 2 shows that implementation 200 may include a splitter module 202, a video decoder 204, and an audio decoder 206 (However, alternate implementations may include greater or fewer decoders in any combination). Also, FIG. 2 shows that video decoder 204 includes a buffer 208, and that audio decoder 206 includes a buffer 210. These elements may be implemented in hardware, software, or any combination thereof.

Splitter module 202 receives an encoded content stream 220 (e.g., stream 122) and based on the stream's characteristics, may divide it two or more substreams. For example, FIG. 2 shows splitter module 202 dividing encoded content stream 220 into an encoded video stream 222 and an encoded audio stream 224. For instance, splitter module 202 may separate encoded audio and video portions from a moving pictures expert group (MPEG) stream (e.g., an MPEG-2 stream). However, the embodiments are not limited to these examples.

Video decoder 204 decodes encoded video stream 222 into a decoded video signal 226. Such decoding may be in accordance with various schemes, such as MPEG-2. However, the embodiments are not limited to this example. With reference to FIG. 1, this decoded signal may be sent to a rendering engine 106.

Audio decoder 206 decodes encoded audio stream 224 into a decoded audio signal 228. Such decoding may be in accordance with various schemes, such as MPEG-2. However, the embodiments are not limited to this example. With reference to FIG. 1, this decoded signal may be sent to a rendering engine 106.

FIG. 2 shows that decoder control module 212 receives a trick mode selection directive 230. With reference to FIG. 1, this directive may be in the form of directive 126. Directive 230 selects a portion of such stored content to be decoded and/or output in accordance with the trick mode(s) specified in command 129. More specifically, directive 230 may select, specify, and/or designate content portions within buffers 208 and 210. In addition, directive 230 specifies various characteristics of the trick mode(s), such as play speed.

Upon receipt of directive 230, decoders 204 and 206 may decode its stored non-trick mode data according to the specified trick-mode(s). This may involve various operations. For example, with fast scan operations, such as fast forward and fast reverse, decoders 204 and 206 may speed up decoding, tweak media time-stamps with the stored content, and/or accelerate output rates (e.g., frame rates). Alternatively, existing output rates may be retained, but information (e.g., video frames) may be dropped. Such dropping may occur either before or after decoding.

For slow scan operations, such as slow forward and slow reverse, decoders 204 and 206 may lower output rates (e.g., frame rates) and tweak time-stamps to freeze presentation of frames. Alternatively, interpolation of information after decoding (e.g., interpolation between frames) may be performed to keep a fixed frame rate.

Reverse operations may involve various techniques, such as decoding all selected content, reverse their order, and modify presentation time-stamps. Alternatively, portions of the selected content (e.g., only vide reference frames) may be decoded and placed in reverse order with modified time-stamps.

Through such operations, beginning and ending points of pre-buffered non-trick mode content can be identified for decoding in accordance with the specified trick modes. Once such content is exhausted, new encoded content may be received that is encoded in accordance with such trick mode(s). Accordingly, an overall smooth trick mode experience may be achieved.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

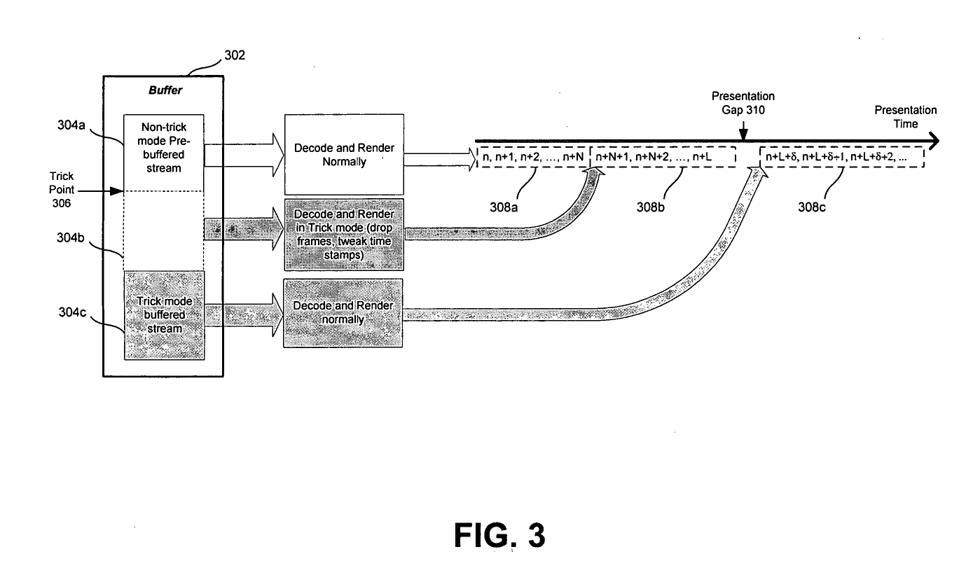

FIG. 3 is a diagram illustrating an exemplary operation. In particular, FIG. 3 shows a buffer 302, which has multiple encoded content portions. These portions include a content portion 304a, and content portion 304b, and a content portion 304c. Content portions 304a and 304b were received in accordance with a normal play (non-trick) mode. As shown in FIG. 3, portion 304a contains encoded content that is decoded and output as a normal mode content stream 308a before a trick mode is selected. With reference to buffer 302, this selection corresponds to a trick point 306, which separates portions 304a and 304b.

Since content portion 304b occurs after trick point 306, it is decoded and rendered in the selected trick mode to produce a trick mode content stream 308b. However, once content portion 304b is exhausted, more content is needed. Accordingly, buffer 302 receives content portion 304c, which is encoded in accordance with the selected trick mode. As a result, content portion 304c may be decoded and rendered normally to produce content stream 308c. As described herein, content portion 304c may be requested within a trick mode connection. Such a connection may be established in response to selection of the trick mode. Within this connection, content portion 304c may be requested at various times. One such time is when content portion 304b is exhausted. The embodiments, however, are not limited to this example.

Through such techniques, presentation gaps in the output of content may be reduced. Although FIG. 3 shows a presentation gap 310, this gap is not as large as it could be for implementations totally relying on remotely generated trick mode content.

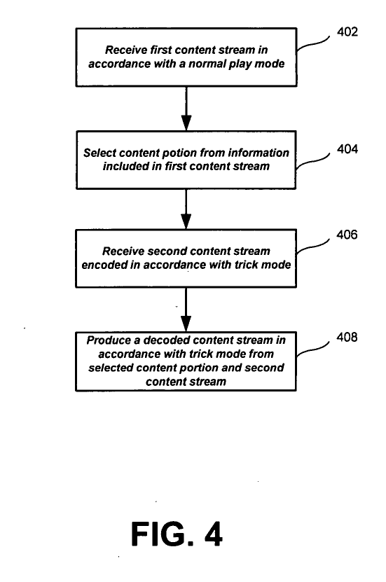

FIG. 4 illustrates one embodiment of a logic flow. FIG. 4 illustrates a logic flow 400. Logic flow 400 may be representative of the operations executed by one or more embodiments described herein. As shown in logic flow 400, a first encoded content stream in accordance with a normal play mode is received at a block 402. This content stream may be received from a remote content source, such as a digital media server.

At a block 404, a content portion is selected from information included in the first encoded content stream. This may be selected, for example, from one or more buffers. At a block 406, a second content stream that is encoded in accordance with the trick mode is received from the content source. This second content stream may be received within a connection or session established for the delivery of trick mode content. As indicated by a block 408, a decoded content stream in accordance with the trick mode is produced, from the selected content portion and the second content stream.

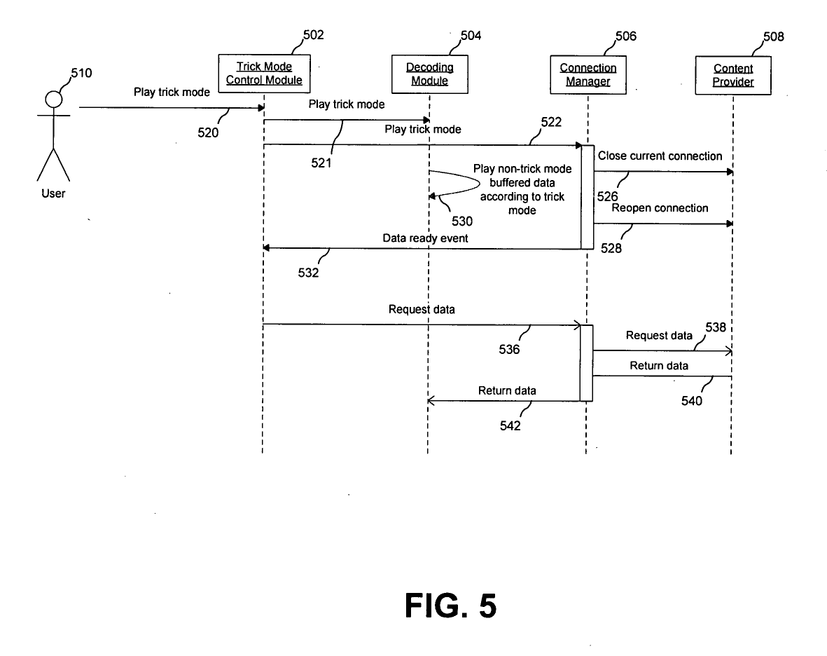

The operation of the above described structures and associated logic flow may be further described by way of an example provided in FIG. 5. In particular, FIG. 5 shows an exemplary interaction between various entities. These entities include a trick mode control module 502, a decoding module 504, a connection manager 506, a content provider 508 (e.g., a digital media server), and a user 510. However, this example may be employed with other entities.

FIG. 5 shows an interaction 520, in which user 510 requests output in accordance with a trick mode. Based on this, interactions 521 and 522 occur in which decoding module 502 and connection manager 506 are directed to play in accordance with the user-requested trick mode.

Accordingly, connection manager 506 closes its current content connection with content provider 508 and reopens it in accordance with the requested trick mode. Also, an interaction 532 indicates that connection manager 506 communicates to trick mode control module 502 that the reopened connection is ready to send data.

Meanwhile, an interaction 530 shows that decoding module 504 decodes (plays), according to the trick mode, currently buffered content that was encoded and received in accordance with a normal play mode. This content may be rendered onto one or more output devices.

Once this buffered content is exhausted, an interaction 536 indicates that trick mode control module 502 directs connection manager 506 to request encoded trick mode data from content provider 508. Thus, connection manager requests and receives such data in interactions 538 and 540. An interaction 542 shows that this content or data is then passed to decoding module 504 for decoding.

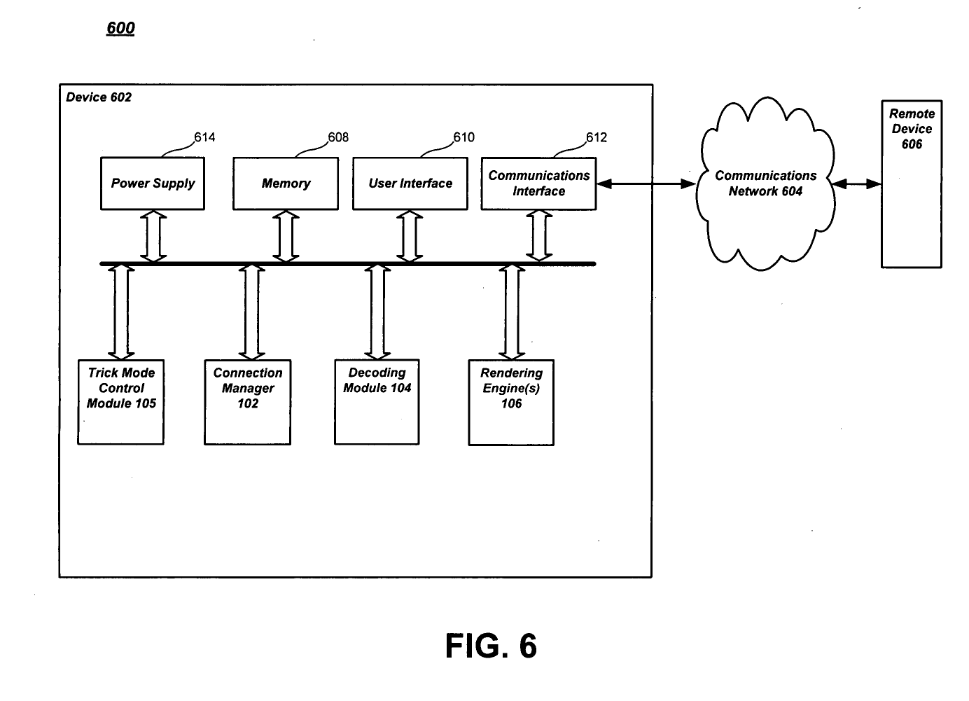

FIG. 6 illustrates an embodiment of a system 600. This system may be representative of a system or architecture suitable for use with one or more embodiments described herein, such as apparatus 100, implementation 200, as well as with logic flow 400, and so forth. Accordingly, system 600 may receive, decode, and/or render content according to techniques, such as the ones described herein. In addition, system 600 may exchange image information with remote devices.

As shown in FIG. 6, system 600 may include a device 602, a communications network 604, and one or more remote devices 606. FIG. 6 shows that device 602 may include the elements of FIG. 1. In addition, device 602 may include a memory 608, a user interface 610, a communications interface 612, and a power supply 614. These elements may be coupled according to various techniques. One such technique involves employment of one or more bus interfaces.

Memory 608 may store information in the form of data. For instance, memory 608 may contain buffers, such as buffers 208, 210, and/or 302. However, the embodiments are not limited in this context. Alternatively or additionally, memory 608 may store control logic, instructions, and/or software components. These software components include instructions that can be executed by a processor. Such instructions may provide functionality of one or more elements in system 600.

Memory 608 may be implemented using any machine-readable or computer-readable media capable of storing data, including both volatile and non-volatile memory. For example, memory 608 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 608 may be included in other elements of system 600. For instance, some or all of memory 608 may be included on a same integrated circuit or chip with as image processing module 106. Alternatively some portion or all of memory 608 may be disposed on an integrated circuit or other medium, for example a hard disk drive, which is external. The embodiments are not limited in this context.

User interface 610 facilitates user interaction with device 602. This interaction may involve the input of information from a user, such as a trick mode command. This interaction may also involve the output of information, such as content, to a user. Accordingly, user interface 610 may include one or more devices, such as a keypad, a touch screen, a microphone, and/or an audio speaker. In addition, user interface 610 may include a display to output information and/or render images/video processed by device 602. Exemplary displays include liquid crystal displays (LCDs), plasma displays, and video displays.

Communications interface 612 provides for the exchange of information with other devices across communications media, such as network. This information may include content, such as image, video, and/or audio transmissions from device 604. Also, this information may include transmissions originated from device 602, such as requests for content and messages managing the status of sessions and/or connections with other devices.

Communications interface 612 may provide for wireless or wired communications. For wireless communications, communications interface 612 may include components, such as a transceiver, an antenna, and control logic to perform operations according to one or more communications protocols. Thus, communications interface 612 may communicate across wireless networks according to various protocols. For example, device 602 and device(s) 606 may operate in accordance with various wireless local area network (WLAN) protocols, such as the IEEE 802.11 series of protocols, including the IEEE 802.11a, 802.11b, 802.11e, 802.11 g, 802.11 n, and so forth. In another example, these devices may operate in accordance with various wireless metropolitan area network (WMAN) mobile broadband wireless access (MBWA) protocols, such as a protocol from the IEEE 802.16 or 802.20 series of protocols. In another example, these devices may operate in accordance with various wireless personal area networks (WPAN). Such networks include, for example, IEEE 802.16e, Bluetooth, and the like. Also, these devices may operate according to Worldwide Interoperability for Microwave Access (WiMax) protocols, such as ones specified by IEEE 802.16.

Also, these devices may employ wireless cellular protocols in accordance with one or more standards. These cellular standards may comprise, for example, Code Division Multiple Access (CDMA), CDMA 2000, Wideband Code-Division Multiple Access (W-CDMA), Enhanced General Packet Radio Service (GPRS), among other standards. The embodiments, however, are not limited in this context.

For wired communications, communications interface 612 may include components, such as a transceiver and control logic to perform operations according to one or more communications protocols. Examples of such communications protocols include Ethernet (e.g., IEEE 802.3) protocols, integrated services digital network (ISDN) protocols, public switched telephone network (PSTN) protocols, and various cable protocols.

In addition, communications interface 612 may include input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Power supply 614 provides operational power to elements of device 602. Accordingly, power supply 614 may include an interface to an external power source, such as an alternating current (AC) source. Additionally or alternatively, power supply 614 may include a battery. Such a battery may be removable and/or rechargeable. However, the embodiments are not limited to this example.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a decoding module to produce a decoded content stream in accordance with a trick mode, the decoded content stream based on a portion of a first encoded content stream in a normal play mode, and a second content stream in the trick mode; and
a control module to select the portion of the first encoded content stream;
wherein the first encoded content stream precedes the second encoded content stream.

2. The apparatus of claim 1, further comprising a connection manager to establish one or more connections with a content source, wherein the one or more connections includes a first connection to receive the first encoded content stream, and a second connection to receive the second encoded content stream.

3. The apparatus of claim 2, wherein the control module is to direct the connection manager to establish the second connection.

4. The apparatus of claim 2, wherein the control module is to direct the connection manager to initiate reception of the second encoded content stream upon exhaustion of the first content portion.

5. The apparatus of claim 1, wherein the decoder module includes a buffer to store information included in the first encoded content stream, and wherein the control module is to designate a portion of the stored information as the first content portion.

6. The apparatus of claim 5, wherein the buffer is to store information included in the second encoded content stream.

7. The apparatus of claim 1, further comprising a rendering engine to drive an output device based on the decoded content stream.

8. The apparatus of claim 1, comprising a display to output one or more images corresponding to the decoded content stream.

9. The apparatus of claim 1, comprising one or more speakers to output an audio signal corresponding to the decoded content stream.

10. An apparatus, comprising:
a decoding module to produce a decoded content stream in accordance with a trick mode, the decoded content stream based on a portion of a first encoded content stream in a normal play mode, and a second content stream in the trick mode;
a connection manager to establish one or more connections with a content source, wherein the one or more connections includes a first connection to receive the first encoded content stream, and a second connection to receive the second encoded content stream; and
a control module to, in response to a user input, select the portion of the first encoded content stream and direct the connection manager to establish the second connection.

11. The apparatus of claim 1, wherein the decoder module includes a buffer to store information included in the first encoded content stream, and wherein the control module is to designate a portion of the stored information as the first content portion.

12. The apparatus of claim 5, wherein the buffer is to store information included in the second encoded content stream.

13. A method, comprising:
receiving a first encoded content stream from a content source in accordance with a normal play mode;
selecting a content portion from information included in the first encoded content stream;
receiving a second encoded content stream from the content source in accordance with a trick mode; and
producing, from the selected content portion and the second content stream, a decoded content stream in accordance with the trick mode.

14. The method of claim 13, comprising receiving a user command to employ the trick mode;

15. The method of claim 13, comprising requesting the second content stream from the content source in accordance with the trick mode.

16. The method of claim 15, wherein the second content stream is requested upon exhaustion of the first content portion.

17. The method of claim 13, comprising storing the information included in the first encoded content stream in a buffer.

18. The method of claim 17, wherein selecting the content portion comprising selecting the content portion from within the buffer.

19. The method of claim 17, comprising storing content information received in the second encoded content stream in the buffer.

20. An article comprising a machine-readable storage medium containing instructions that if executed enable a system to receive a first encoded content stream from a content source in accordance with a normal play mode;
select a content portion from information included in the first encoded content stream;
receive a second encoded content stream from the content source in accordance with a trick mode; and
produce, from the selected content portion and the second content stream, a decoded content stream in accordance with the trick mode.
